(19) United States
(12) Patent Application Publication
(10) Pub. No.: US 2010/0328930 A1
(43) Pub. Date: Dec. 30, 2010

(54) Energy-saving fluorescent lamp

(76) Inventors: Ming-Jung Wu, Chiayi City (TW); Ching-Fu Tsai, Chiayi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,045

(22) Filed: Jun. 30, 2009

(51) Int. Cl. F21L 4/00

(52) U.S. Cl. 362/183

(57) ABSTRACT

This invention relates to an energy-saving fluorescent lamp in which a solar energy collection unit is provided on the reflection hood of the fluorescent lamp, the solar energy collection unit being connected to a power storage unit through the circuit of a light-to-electricity converting unit, the power storage unit being capable of supplying electricity to the fluorescent lamp tube, a control unit being further provided between the power storage unit and the fluorescent lamp tube, the power storage unit being controlled by the control unit in such a manner that the power is supplied to the tube only when the power storage unit is stored with electricity, otherwise the tube being still supplied with electricity of utility power. In this manner, energy-saving effect can be achieved.

### BACKGROUND OF THE INVENTION

1. Field of the Invention

This invention relates to an energy-saving fluorescent lamp, particularly to a novel fluorescent lamp having energy-saving effect, in which the illumination light of the fluorescent lamp tube can be converted into electricity, and the electricity thus converted can be used as the power source of the fluorescent lamp tube.

2. Brief Description of Prior Art

In living environment with limited land and dense population, residence and office buildings are constructed in limited space. Thus, layouts of building itself or its internal partitions are conducted under the principle of accomplishing the utmost benefit of land. Accordingly, ambient lighting of building is possibly to be sacrificed or neglected so that the lamps in the interior of residence or office have to be turned on for providing light and spacious life space even in daytime with strong sunshining. This is mostly common in ordinary office in which the number of fluorescent lamp tube used is relatively so many. Under the price upsurging of electricity caused by energy crisis and emphasis on energy-saving as well as carbon reduction, this will become a big burden on electricity expense and possesses no EV concept.

Therefore, if a fluorescent lamp having energy-saving effect so as to reduce electricity expense on consumer side is proposed, the abovementioned problem can be solved.

### SUMMARY OF THE INVENTION

In view of the above facts, inventor of the present invention unveils an energy-saving fluorescent lamp which enables the reduction of energy consumption.

The object of this invention is to provide an energy-saving fluorescent light in which the illumination light of the fluorescent lamp tube is converted into electricity and is stored; the electricity thus converted being used as another power source of the fluorescent lamp tube. In this manner, the fluorescent lamp can achieve the effect of energy-saving.

In order to achieve the object, an energy-saving fluorescent lamp is provided, in which a solar energy collection unit is provided on the reflection hood of the fluorescent lamp, the solar energy collection unit being connected to a power storage unit through the circuit of a light-to-electricity converting unit so as to store the electricity converted by the light-to-electricity converting unit and to supply the electricity stored in the power storage unit to the fluorescent lamp tube, a control unit being further provided between the power storage unit and the fluorescent lamp tube, the power storage unit being controlled by the control unit in such a manner such that the power is supplied to the tube only when the power storage unit is stored with electricity, otherwise the tube being still supplied with electricity of utility power. In this manner, energy-saving effect can be achieved.

### BRIEF DESCRIPTION OF THE DRAWINGS

FIG. 1 is a perspective exploded view showing the structure of the energy-saving fluorescent lamp of the present invention.

FIG. 2 is a schematic side view showing the structure of the energy-saving fluorescent lamp of the present invention.

FIG. 3 is a block diagram showing the structure of the energy-saving fluorescent lamp of the present invention.

### DETAILED DESCRIPTION OF PREFERRED EMBODIMENTS

The technical content, object and effectiveness of the present invention will become more apparent by the detailed description of preferred embodiments of the present invention in conjunction with the accompanying drawings.

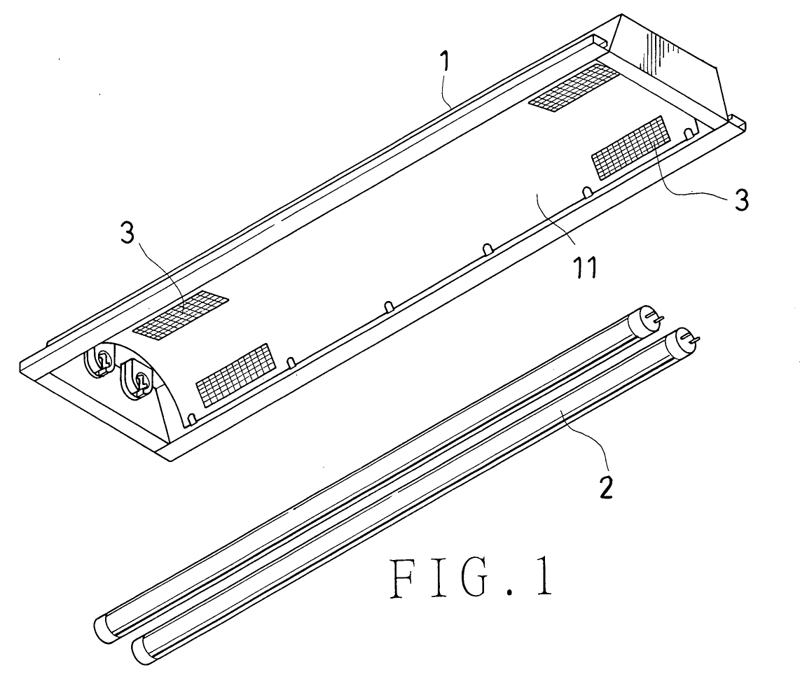

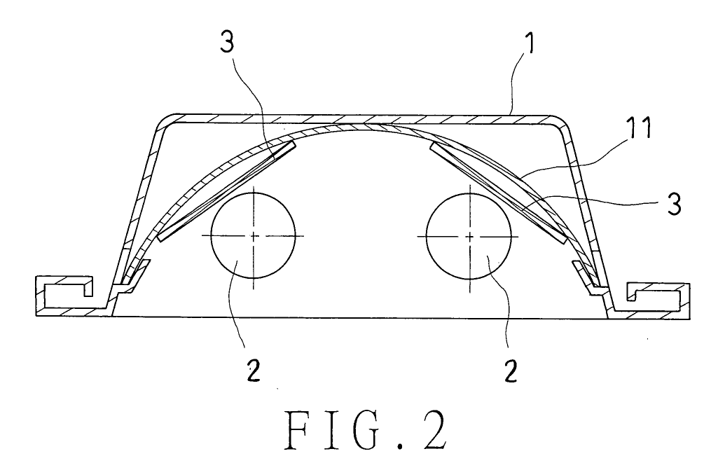

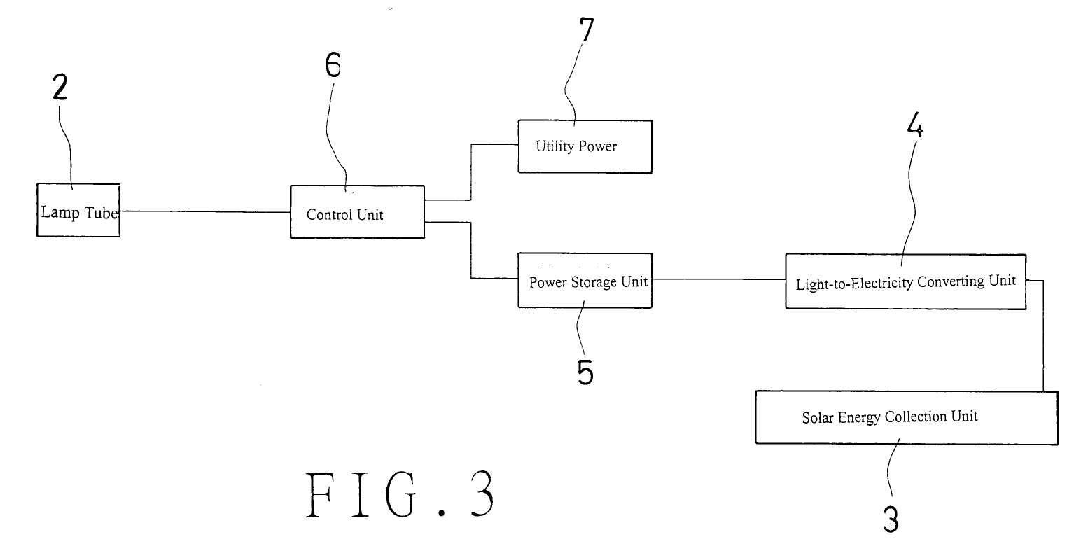

FIG. 1 is a perspective exploded view showing the structure of the energy-saving fluorescent lamp of the present invention; FIG. 2 is a schematic side view showing the structure of the energy-saving fluorescent lamp of the present invention; FIG. 3 is a block diagram showing the structure of the energy-saving fluorescent lamp of the present invention.

Referring to FIGS. 1 to 3, the energy-saving fluorescent lamp of the present invention comprises a lamp base (1), at least one lamp tube (2), a solar energy collection unit (3), a light-to-electricity converting unit (4), a power storage unit (5), and a control unit (6), in which:

a reflection hood (11) is provided on the lamp base (1) and the lamp tube (2) is installed on the reflection side of the reflection hood (11), the light emitted from the lamp tube (2) being irradiated in a region after reflection and collection by the reflection hood (11); a solar energy collection unit (3) being provided on the reflection surface of the reflection hood (11), the output end of the solar energy collection unit (3) being connected to the light-to-electricity converting unit (4) and in turn to the power storage unit (5) the output terminal of which is connected to the circuit of the lamp tube (2) through a control unit (6), the control unit (6) being also connected to the utility power (7).

With this structure, the lamp tube (2) of the fluorescent lamp is usually supplied with electricity by utility power (7). When the lamp tube (2) is energized to emit light, the solar energy collection unit (3) begins to collect light energy, and then the light energy collected by solar energy collection unit (3) is converted into electricity by the light-to-electricity converting unit (4) and is stored in the power storage unit (5). When the control unit (6) detects the electric power energy stored in the power storage unit (5) being enough to drive the lamp tube (2), the control unit (6) interrupts the electricity supply from the utility power (7) and simultaneously switches the power supply from the power storage unit (5) to the lamp tube (2). If the power storage unit (5) becomes incapable of supplying electricity to the lamp tube (2), then the control unit (6) will recover the electricity supply from the utility power (7) to the lamp tube (2). If the power storage unit (5) becomes full again, then it has the first priority to supply power to the lamp tube (2) again. Through the repeated cycle of light collection, power storage, and power supply, the time interval of supplying utility power (7) to the lamp tube can be reduced so that the energy-saving effect can be achieved.

Based on the foregoing description, the light energy can be collected by the solar energy collection unit when the tube of the fluorescent lamp of the present invention is energized, the light energy being converted into electricity by the light-to-electricity converting unit and then the electricity being stored in the power storage unit, the electricity stored in the power storage unit being used as the power supplying source for the fluorescent lamp tube, especially when the tube of the fluorescent lamp of the present invention is energized, the power storage unit being uninterruptedly stored with electricity such that the power storage unit of the fluorescent lamp can supply power to the tube in self-sufficiency manner. Therefore, the time interval of supplying utility power (7) to the lamp tube can be remarkably reduced so that the energy-saving effect of the fluorescent lamp can be achieved.

Summing up above, the above embodiments of this invention can reach expected effectiveness, and the specific structure disclosed herein has yet not seen in the prior art of the same category of product, even has not been opened to the public before application.

What is claimed is:

1. An energy-saving fluorescent lamp, wherein a solar energy collection unit is provided on the reflection hood of said fluorescent lamp, said solar energy collection unit being connected to a power storage unit through the circuit of a light-to-electricity converting unit so as to store the electricity obtained by the conversion of said light-to-electricity converting unit, the output end of said power storage unit being connected to a control unit which is provided between the utility power and the fluorescent lamp tube; with this structure, said power storage unit being controlled by said control unit in such a manner that the electricity stored in said power storage unit is supplied to the lamp tube only when said power storage unit is stored with electricity, otherwise said lamp tube is still supplied with electricity of utility power.
